(19) United States
(12) Patent Application Publication
(10) Pub. No.: US 2010/0017588 A1
(43) Pub. Date: Jan. 21, 2010

(54) SYSTEM, METHOD, AND COMPUTER PROGRAM PRODUCT FOR PROVIDING AN EXTENDED CAPABILITY TO A SYSTEM

(76) Inventor: Radoslav Danilak, Cupertino, CA (US)

Correspondence Address: Zilka-Kotab, PC, P.O. BOX 721120, SAN JOSE, CA, 95172-1120, US

(21) Appl. No.: 12/173,631

(22) Filed: Jul. 15, 2008

(51) Int. Cl. G06F 9/00

(52) U.S. Cl. 713/2

(57) ABSTRACT

A system, method, and computer program product are included for providing an extended capability to a system. In operation, a request to boot a system is identified. Additionally, in response to the request, extended capability code is returned. Furthermore, the extended capability code is capable of being executed to provide an extended capability.

### FIELD OF THE INVENTION

The present invention relates to computer systems, and more particularly to extending capabilities to such systems.

### BACKGROUND

In general, system storage devices are attached to a computer through integrated drive electronics (IDE), a serial advanced technology attachment (SATA), a small computer system interface (SCSI), a serial attached SCSI (SAS), or a peripheral component interconnect express (PCIE), etc. Basic input/output systems (BIOS) used during a boot process read predefined blocks from the system storage devices and execute code that is read. Often, the code is operating system code. However, in some cases, the code may include system diagnostic code or other utility code.

Commonly, storage device capabilities are limited by the protocol the storage device uses to communicate with the host system, such as an advanced technology attachment (ATA), or SCSI command set, etc. In many cases, extending the capabilities of storage devices is difficult. For example, extending the capabilities of storage devices often requires modifying communication protocols, host bus adapters, device drivers, and software applications.

Furthermore, current software based solutions boot from unencrypted partitions of the storage devices, leaving those partitions vulnerable to attack. In addition, because such solutions are often required to modify operating systems, the current software solutions have a problem resuming operation from a hibernation state. There is thus a need for addressing these and/or other issues associated with the prior art.

### SUMMARY

A system, method, and computer program product are included for providing an extended capability to a system. In operation, a request to boot a system is identified. Additionally, in response to the request, extended capability code is returned. Furthermore, the extended capability code is capable of being executed to provide an extended capability.

### BRIEF DESCRIPTION OF THE DRAWINGS

FIG. 1 shows a method for providing an extended capability, in accordance with one embodiment.

FIG. 2 shows a system for providing an extended capability, in accordance with one embodiment.

FIG. 3 shows a method for providing an extended capability, in accordance with another embodiment.

FIG. 4 illustrates an exemplary system in which the various architecture and/or functionality of the various previous embodiments may be implemented.

### DETAILED DESCRIPTION

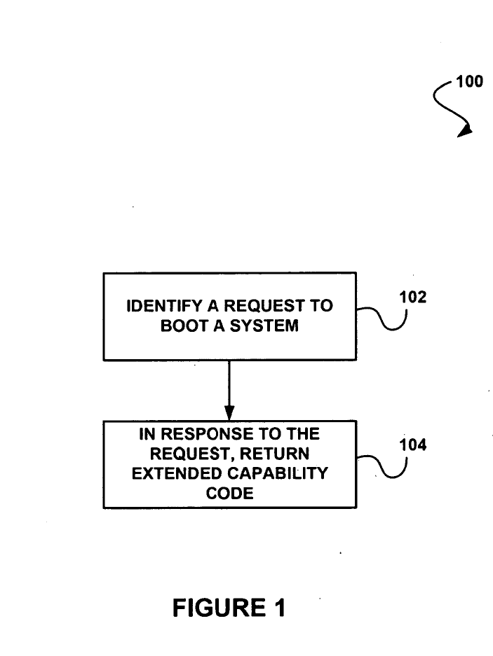

FIG. 1 shows a method 100 for providing an extended capability, in accordance with one embodiment. As shown, a request to boot a system is identified. See operation 102. In one embodiment, the request to boot may be received and/or identified by a storage device.

In the context of the present description, a storage device refers to any device capable of storing data. For example, in various embodiments, the storage device may include, but is not limited to, a hard disk drive, flash memory, removable storage (e.g. CDs, DVDs, etc.), and/or any other type of storage device. Additionally, the storage device may be internal or external to the system.

Furthermore, in the context of the present description, a system refers to any system capable of being booted. For example, in various embodiments, the system may include, but is not limited to, a desktop computer, a laptop computer, a handheld computer, a personal digital assistant (PDA) device, a mobile phone, and/or any other system that meets the above definition. Additionally, the term “boot” refers to any process for starting or initiating the start of an operating system.

As shown further, in response to the request, extended capability code is returned. See operation 104. In the context of the present description, extended capability code refers to any code that is capable of extending a capability that is not included in a boot sector. Furthermore, the extended capability code is capable of being executed to provide an extended capability.

The extended capability may include any number of capabilities. For example, in various embodiments, the extended capability may include an extended communication capability, an extended security capability, an extended data back-up capability, and/or an extended statistics capability. In one embodiment, the extended capability may include writing data to boot code. As an option, the extended capability may include retrieving additional extended capability code, where the additional extended capability code is capable of being executed to provide an additional extended capability.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

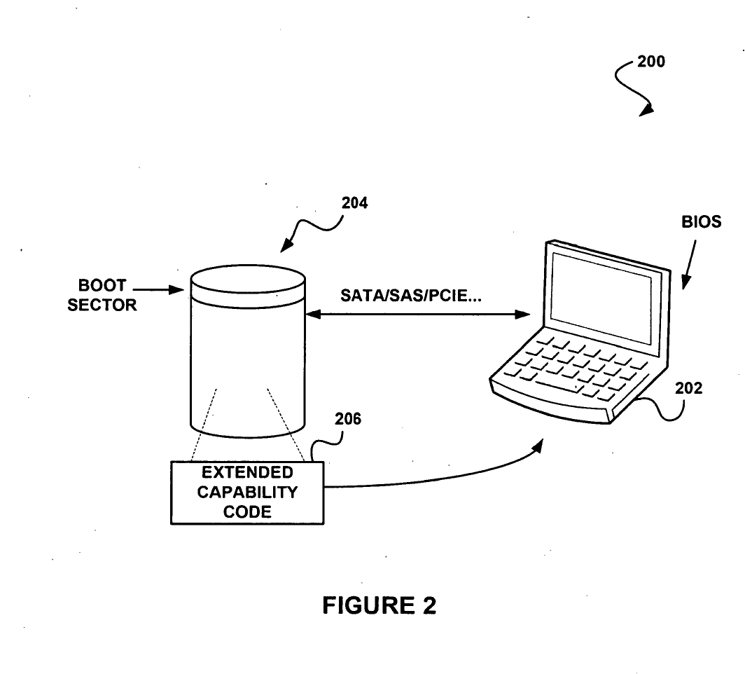

FIG. 2 shows a system 200 for providing an extended capability, in accordance with one embodiment. As an option, the present system 200 may be implemented to carry out the method 100 of FIG. 1. Of course, however, the system 200 may be implemented in any desired environment. It should also be noted that the aforementioned definitions may apply during the present description.

As shown, a host system 202 is in communication with a storage device 204. In various embodiments, the host system 202 may be in communication with the storage device 204 through various protocols, such as integrated drive electronics (IDE), a serial advanced technology attachment (SATA), a serial attached SCSI (SAS), or peripheral component interconnect express (PCIE), etc. Of course, the host system 202 may be in communication with the storage device 204 through any suitable protocol.

As an option, the host system 202 may be in communication with the storage device 204 over one or more networks. In such case, the networks may include any type of network. For example, the network may include a telecommunications network, a local area network (LAN), a wireless network, a wide area network (WAN) such as the Internet, a peer-to-peer network, and/or a cable network, etc.

In operation, the storage device 204 may identify a request to boot from the host system 202. In response to the request, extended capability code 206 may be returned from the storage device 204 to the host system 202. In this case, the extended capability code 206 may be returned from the storage device 204 to the host system 202 via the communication protocol.

It should be noted that, although the storage device 204 is illustrated as a single device, in other embodiments, a plurality of storages devices may be utilized. For example, in one embodiment, the request to boot may be received by a single storage device. In another embodiment, the request may be received by a plurality of storage devices.

Once the extended capability code 206 is returned, the extended capability code 206 may be executed to provide an extended capability. As an option, boot code may be substituted with the extended capability code. In this case, the host system 202 may utilize the extended capability code 206 in a boot operation.

As another option, after the extended capability code 206 is returned, boot code may be returned. In this case, the boot code may be provided by the storage device 204 after the extended capability code 206 is returned. Furthermore, the boot code may be executed after execution of the extended capability code 206 by the host system 202.

It should be noted that, in various embodiments, the storage device 204 may be a bootable device or a non-bootable device. For example, in the case that the storage device 204 is a bootable device, the host system 202 may boot using all or some of the information stored on the storage device 204. In one embodiment, the host system 202 may be automatically booted from the storage device 204. In another embodiment, an option may be presented to boot from the storage device 204.

In the case that the storage device 204 is a non-bootable device, the host device 202 may boot using a different external or internal device. As an option, boot code may be returned to the host system 202 from the storage device 204 such that the host system 202 may boot using the returned code. In this case, a user may be presented with an option to boot using boot code returned by the storage device 204.

As an example, a request to load operating system information may be identified by the storage device 204. In response to the request, the extended capability code 206 may be returned by the storage device 204, where the extended capability code 206 is capable of being executed to provide an extended capability.

As another example, booting may occur from a bootable device capable of executing the extended capability code 206. Upon execution, the extended capability code 206 may operate to search for other storage devices that may have an extended capability. If non-boot devices with extended capabilities are found, extended capabilities for these devices may be invoked and/or provided.

In one embodiment, the extended capability code 206 and/or boot code may be returned as a data structure. For example, a data structure may be embodied on the storage device 204 or another computer readable medium, where the data structure includes a bios object and extended capability code included with the bios object providing an extended capability in response to execution.

It should be noted that, in various embodiments, the storage device 204 may include any device capable of storing information. For example, in various embodiments, the storage device 204 may include a disk drive, a CD, a DVD, a USB drive, and/or any other storage device.

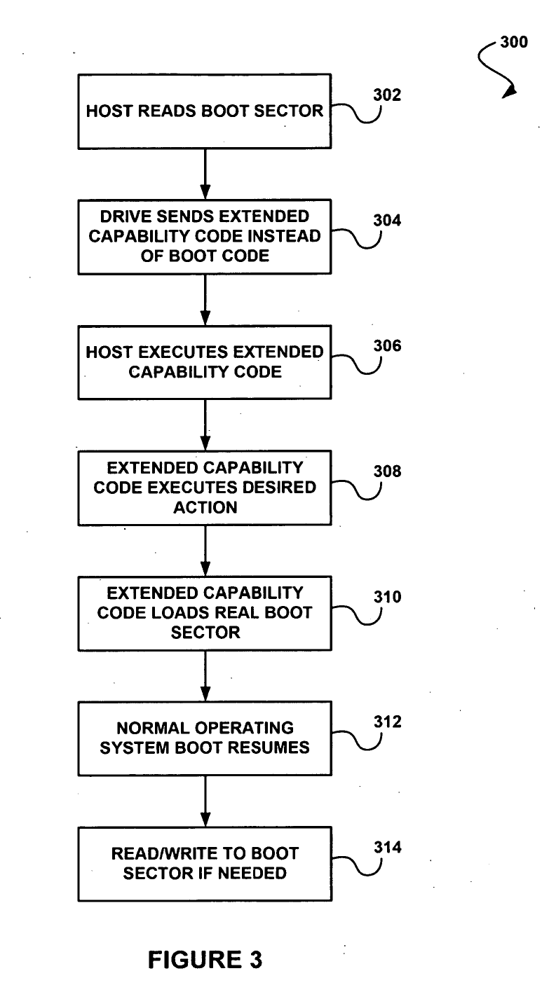

FIG. 3 shows a method 300 for providing an extended capability, in accordance with another embodiment. As an option, the present method 300 may be implemented in the context of the functionality and architecture of FIGS. 1-2. Of course, however, the method 300 may be carried out in any desired environment. Again, the aforementioned definitions may apply during the present description.

As shown, a host reads a boot sector of a storage device, such as a disk drive. See operation 302. Instead of sending boot code, the drive sends extended capability code. See operation 304.

The host receives and then executes the extended capability code. See operation 306. Subsequently, the extended capability code executes a desired action. See operation 308.

For example, in various embodiments, the extended capability code may include executing an extended communication capability code, an extended security capability code, an extended data back-up capability code, and/or an extended statistics capability code. As an option, the execution of the extended capability code may include writing data to boot code. In this case, the execution of the extended capability code may include modifying pre-existing boot code.

In one embodiment, communicating capabilities may be extended by providing a password to decrypt the drive. For example, systems using software based solution often boot from an unencrypted partition, leaving that partition vulnerable to attack. In addition, such systems may implement a modified operating system. Thus, problems may occur on resumption from hibernation by loading unprotected random access memory (RAM) images.

However, by using the extended capability code, the password may be communicated, transparently extending capabilities of a storage device before an operating system is loaded, such that the operating system need not be modified. Since the password may be used to decrypt the storage device before access, the storage device will not be vulnerable to attack when the operating system operation is resumed. Additionally, along with the extended capability code, additional information may be communicated to a host system such as a type of processor, an amount of memory, a date, and/or a time, etc.

As shown further in FIG. 3, once the extended capability code executes the desired action, the extended capability code loads the real boot sector. See operation 310. In one embodiment, the extended capability code may be included in a data structure along with a bios object. In this case, the bios object may be associated with the real boot sector that is loaded after the execution of the extended capability code.

Once the extended capability code has been executed and the real boot sector has been loaded, the normal operating system boot is resumed. See operation 312. Furthermore, data may also be read from or written to the boot sector and/or to other locations on the disk. See operation 314. For example, data such as a type of processor, an amount of memory, a date, and a time, etc., may be read from or written to the boot sector.

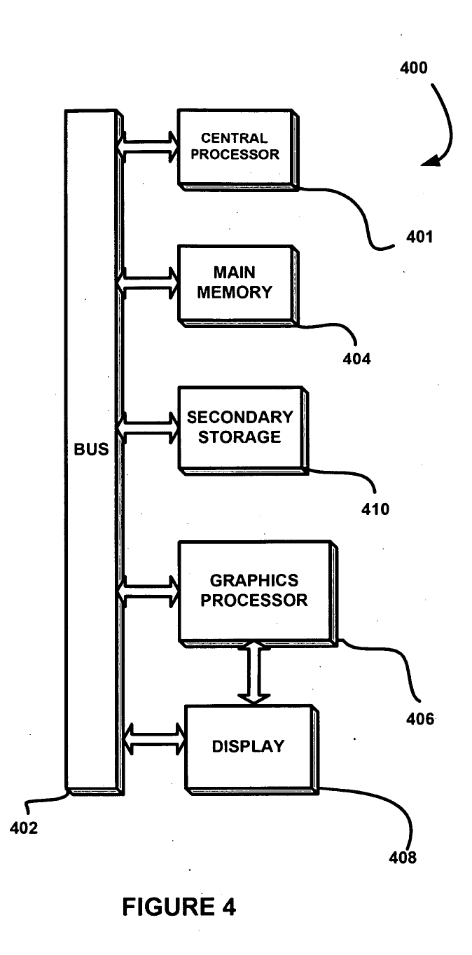

FIG. 4 illustrates an exemplary system 400 in which the various architecture and/or functionality of the various previous embodiments may be implemented. As shown, a system 400 is provided including at least one host processor 401 which is connected to a communication bus 402. The system 400 also includes a main memory 404. Control logic (software) and data are stored in the main memory 404 which may take the form of random access memory (RAM).

The system 400 also includes a graphics processor 406 and a display 408, i.e. a computer monitor. In one embodiment, the graphics processor 406 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 400 may also include a secondary storage 410. The secondary storage 410 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 404 and/or the secondary storage 410. Such computer programs, when executed, enable the system 400 to perform various functions. Memory 404, storage 410 and/or any other storage are possible examples of computer-readable media.

In one embodiment, the architecture and/or functionality of the various previous figures may be implemented in the context of the host processor 401, graphics processor 406, an integrated circuit (not shown) that is capable of at least a portion of the capabilities of both the host processor 401 and the graphics processor 406, a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 400 may take the form of a desktop computer, lap-top computer, and/or any other type of logic. Still yet, the system 400 may take the form of various other devices including, but not limited to, a PDA device, a mobile phone device, a television, etc.

Further, while not shown, the system 400 may be coupled to a network [e.g. a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
identifying a request to boot a system; and
in response to the request, returning extended capability code;
wherein the extended capability code is capable of being executed to provide an extended capability.

2. The method as set forth in claim 1, wherein the request is received by a single storage device.

3. The method as set forth in claim 1, wherein the request is received by a plurality of storage devices.

4. The method as set forth in claim 1, wherein boot code is substituted with the extended capability code.

5. The method as set forth in claim 1, wherein, after the extended capability code is returned, boot code is returned.

6. The method as set forth in claim 5, wherein the boot code is executed after execution of the extended capability code.

7. The method as set forth in claim 1, wherein the extended capability code is executed by a host.

8. The method as set forth in claim 1, wherein the extended capability includes an extended communication capability.

9. The method as set forth in claim 1, wherein the extended capability includes an extended security capability.

10. The method as set forth in claim 1, wherein the extended capability includes an extended data back-up capability.

11. The method as set forth in claim 1, wherein the extended capability includes an extended statistics capability.

12. The method as set forth in claim 1, wherein the extended capability includes retrieving additional extended capability code, where the additional extended capability code is capable of being executed to provide an additional extended capability.

13. The method as set forth in claim 1, wherein the extended capability includes writing to boot code.

14. The method as set forth in claim 1, wherein after execution of the extended capability code, data is capable of being read from or written to locations on a disk, including a boot sector on the disk.

15. The method as set forth in claim 1, wherein the request is received by a bootable device.

16. The method as set forth in claim 1, wherein the request is received by a non-bootable device.

17. A method, comprising:
identifying a request to load operating system information; and
in response to the request, returning extended capability code;
wherein the extended capability code is capable of being executed to provide an extended capability.

18. The method as set forth in claim 17, wherein the extended capability includes an extended communication capability.

19. The method as set forth in claim 17, wherein the extended capability includes an extended security capability.

20. The method as set forth in claim 17, wherein the extended capability includes an extended data back-up capability.

21. A data structure embodied on a computer readable medium, comprising:
a bios object; and
extended capability code included with the bios object providing an extended capability in response to execution.

22. An apparatus, comprising:
a storage device for receiving a request to boot a system; and
an interface for returning extended capability code in response to the request; wherein the extended capability code is capable of being executed to provide an extended capability.
